(19) United States
(12) Patent Application Publication
(10) Pub. No.: US 2017/0256970 A1
(43) Pub. Date: Sep. 7, 2017

(54) PAIRABLE USB CABLE LOCKING CHARGER

(71) Applicants: MARTIN CIESINSKI, NORTHPORT, NY (US); JAIME CIESINSKI, NORTHPORT, NY (US); JUSTINE CIESINSKI, NORTHPORT, NY (US); DONNA CIESINSKI, NORTHPORT, NY (US)

(72) Inventors: MARTIN CIESINSKI, NORTHPORT, NY (US); JAIME CIESINSKI, NORTHPORT, NY (US); JUSTINE CIESINSKI, NORTHPORT, NY (US); DONNA CIESINSKI, NORTHPORT, NY (US)

(21) Appl. No.: 15/450,951

(22) Filed: Mar. 6, 2017

Related U.S. Application Data
(60) Provisional application No. 62/303,568, filed on Mar. 4, 2016.

(51) Int. Cl. H02J 7/00; G06F 9/445; H01R 24/64; H02M 7/04; H01R 13/639

(52) U.S. Cl. CPC H02J 7/0052; H02J 7/0047; H02J 7/0044; H02M 7/04; H01R 13/6397; H01R 24/64; G06F 9/445; H02J 2007/0059; H02J 2007/0062; H02J 2007/005; H01R 2107/00

(57) ABSTRACT

The invention seeks to solve the problem of theft or “borrowing” of a charging device to deprive the owner of the device when needed. This can be done by using Bluetooth or other protocol to “pair” a charger to the device being charged and locking or otherwise disabling the charger except when properly paired so that only the owner of the charger can make use of it. The charger can be enabled electronically only when properly paired. Also, when the adapter and the cable are physically detachable the device can also be optionally provided with electro-mechanical or other locking means for securing the cable to the adapter so that it cannot be separated from the charger except when paired.

### BACKGROUND OF THE INVENTION

Field of the Invention

The invention generally relates to A.C. to D.C. chargers for mobile devices and, more specifically, to a pairable USB charger for selectively enabling the charger and/or locking the charging cable of an authorized user to the charger.

Description of the Prior Art

Electronic devices need to be frequently charged. When there are children in a household or co-workers in an office, it is not uncommon for someone to borrow a charger and/or a charging cord for a mobile device to charge their device. There is, then, a possibility that it will not be returned. For this reason replacement chargers and cords are huge sellers at retailers and convenience stores as an impulse purchase or a necessity.

Most Electronic devices today are charged by using a USB AC Power Adapter that gets plugged directly into a wall socket. A USB charging cable is connected to the AC charger via a standard Universal Serial Bus (USB) port male plug. The other end plugs directly into the device to be charged. (phone, tablet, camera etc.)

Known is a charging device that is enabled by means of a relay when there is pairing between the device to be charged and the charging device. The problem sought to be addressed was the unauthorized use of the charging device by numerous users, such as in a mall or other public venue as this would result in “accelerated aging” of the equipment and shorten its life span.

In International Publication WO2014/080198 an induction charger is disclosed that uses pairing by Bluetooth or the like where devices require a high degree of security for data that they store. The security is assured by allowing charging and, therefore, electronic coupling of the devices only when pairing is affected.

In U.S. Published Application 2010/0184382 a charging device is disclosed for portable electronic devices that initiates charging only when there is coupling involved. Physical coupling over various pairing approaches can also be used. The patent relies strictly on a “physical coupling” to initiate the charging process.

In U.S. Pat. No. 8,805,456 a wireless charging base is disclosed that only activates the wireless charging feature when there is Bluetooth communication between the charger and the device to be charged by Bluetooth or the like.

Also known are USB connectors that can be selectively locked or unlocked, similarly to the one disclosed in the U.S. Published Patent Application 20150020189. Thus, there is known a locking arrangement for securing USB connectors in place so that “unauthorized or inadvertent disconnection or decoupling of the USB connector becomes difficult or virtually impossible”. U.S. Pat. No. 7,578,691, teaches that there is “a very wide variety of locking/unlocking protocols” for locking or unlocking the USB connector. The patent suggests that unlocking can be automatic when a computer is shut down while unlocking can take place automatically when the computer is booted up.

In U.S. Pat. No. 7,751,183 different release mechanisms are disclosed including a biometric reader for reading a biometric identification of the user in order to unlock the USB device.

In Chinese Patent CN204231780 a Flash Drive-Type Storage Unit is disclosed that includes an anti-pull arrangement to prevent unauthorized removal of the device from a computer or the like and allow the device to be removed only upon entry of a password.

The USB connector locking patents, however, do not appear to make reference to the application to charging units or power adapters or the use of Bluetooth authentication and a locking device for use with power adapters or chargers.

In view of the foregoing, it is clear that none of these patents are primarily concerned with theft or unauthorized “borrowing” of a charger or a portion thereof. However, techniques have been disclosed for preventing or starting the charging process except when authorized by interchange of coded data or, in some cases, by physical or proximity coupling. It appears, therefore, that the results may disclose some aspects of the proposed device. What none of these references disclose is a locking feature, specifically the feature that the adapter and the cable are physically attachable or detachable with an electro-mechanical means for securing the cable to the adapter so that they cannot be separated except when paired.

### SUMMARY OF THE INVENTION

The invention seeks to solve the problem of theft or “borrowing” of a charging device to deprive the owner of the device when needed. This could be done by using Bluetooth or other pairing technology to “pair” a charger to the device being charged and locking or otherwise disabling the charger except when properly paired so that only the owner of the charger can make use of it. The charger can be enabled electronically only when properly paired. Also, when the adapter and the cable are physically detachable the device can also be optionally provided with electro-mechanical or other locking means for securing the cable to the adapter so that it cannot be separated from the charger except when paired.

Features of the invention include:

Pairing:

Phone or Laptops can be paired to the charger, utilizing Bluetooth or other standardized pairing technology. If device is not paired, it will not allow that device to be charged.

Exclusivity:

The charger pairs with the first device that connects to it. Once paired it cannot be paired with a second device.

Charger Mechanically Locks a Detachable USB Charging Cable into USB Charging Port.

Locking of the cord can be achieved in multiple ways. Once locking is engaged the charging cable cannot be released without the paired device's interaction with the application software.

This feature protects from:
Loss of the cord.
If the charging cable becomes damaged or defective, it can be released and replaced without the need to buy a new charger.
Charger can be used with all USB cables. Different devices have different USB connector ends.

### BRIEF DESCRIPTION OF THE DRAWINGS

Those skilled in the art will appreciate the improvements and advantages that derive from the present invention upon reading the following detailed description, claims, and drawings, in which:

FIG. 1 is a block diagram of a charging unit in accordance with the invention;

FIG. 2 is a front elevational schematic view of a female USB receptacle port used in the charging unit shown in FIG. 1, showing an actuator pin for a selectively locking or releasing a USB plug of the type typically used on USB charging cables for charging mobile devices;

FIG. 3 is a perspective schematic representation of a USB plug of the type receivable within the receptacle shown in FIG. 2;

FIG. 4a is a representation of a modified housing for a charging unit for use with a wide variety of USB plugs, showing a lid or door in an open position;

FIG. 4b is similar to FIG. 4a and showing a partial slit or slot in the door or lid open on an edge thereof opposite to a living hinge and also illustrating a printed circuit board removed from the housing bearing the electronics for mating with a mobile device and a USB receptacle;

FIG. 4c is similar to FIGS. 4a and 4b but shows the lid or door closed after a USB plug has been inserted into the internal USB receptacle with the charging cable received through the slit or slot and the door or lid secured in the locked position to prevent the USB plug to be withdrawn from the internal USB receptacle and the charging cable separated from the housing of the charging unit;

FIG. 5 is a flow diagram of the software embodied or incorporated in the modified charging unit of FIG. 1 for achieving the desired functions;

FIG. 6 outlines the software options achievable with the software depicted or represented by the flowchart shown in FIG. 4; and

FIG. 7 is a hardware flowchart illustrating the interaction between the software and hardware implementations to achieve the functions or options outlined in FIG. 5.

### DETAILED DESCRIPTION OF A PRESENTLY PREFERRED EMBODIMENT

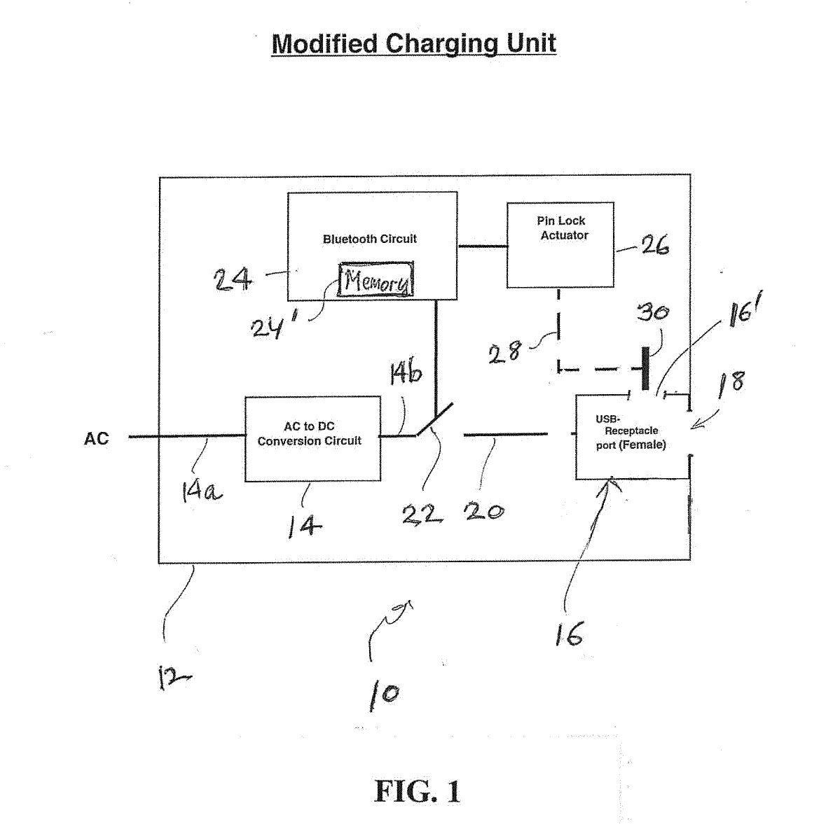

Referring to the figures, in which identical or similar parts are designated by the same reference numerals throughout, and first referring to FIG. 1, a charging unit in accordance with the invention is generally designated by the reference numeral 10.

The charging unit 10 includes a housing 12 containing an AC to DC conversion unit 14. The conversion unit 14 may be any conventional conversion unit having an input 14a connectable to a source of AC power and an output 14b providing desired DC voltage to, for example, a type-A USB female receptacle 16 for use with a mobile or other device to be charged through the USB connector or receptacle port 18.

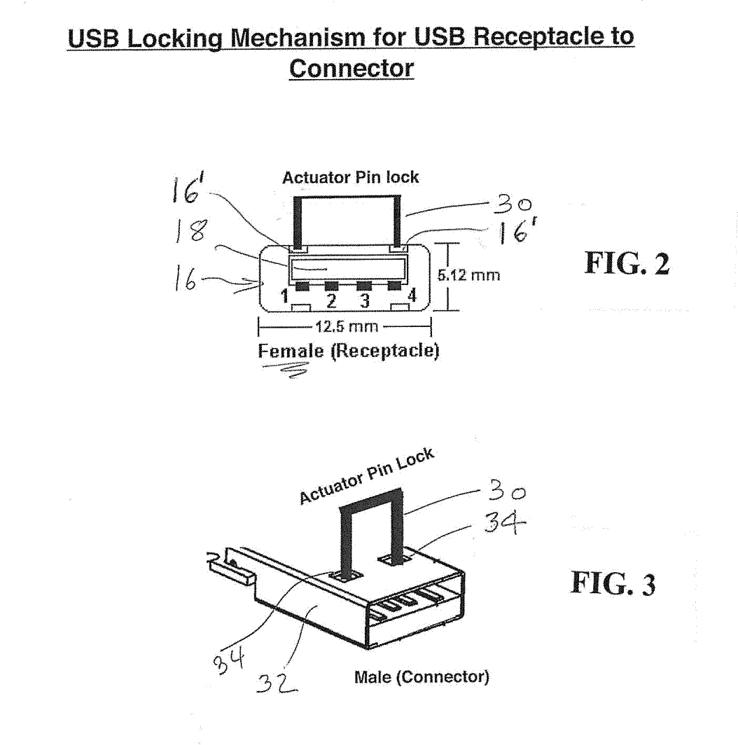

While there are several types of USB connectors, the original and most common USB connector shown in FIGS. 2 and 3 are the standard-A plugs and receptacles. The standard-A plugs are provided with a rectangular protective metal sheath or shield that is formed with two spaced square holes on a side opposite and spaced from a plastic contact-supporting tongue within the metal sheath or shield. These holes are intended to align or register with two-spring tabs cut in the shield of the female receptacle or port and bent in the direction of the sheath or shield in the plug to provide a press-fit contact or engagement with the male port to insure that the connection between the plug and receptacle is stable and not loose. To separate the male plug and female receptacle and break the connection a user needs to apply some force to overcome the retaining forces applied by the spring tabs. Different USB connector types have different sheath or shield cross-sections and different hole configurations or arrangements in the sheaths or shields, such as the single holes in the Mini-A and Mini-B plugs. The invention is intended to be used with and USB sheaths or shields that have at least one hole or recess that can receive and/or engage a pin or other member for an interface fit between a plug and an associated receptacle.

The USB receptacle 18 is provided with an input line 20 connectable to the output line 14b by means of a switch 22. The switch 22 is a selectively controlled by a Bluetooth circuit 24 or other means. The Bluetooth circuit 24 may be any conventional Bluetooth circuit that can be used to actuate the switch 22 by a suitable Bluetooth device such as a cell phone, tablet, etc. that can be paired to the Bluetooth circuit 24. The switch 22 is normally open and closes to apply the D.C. voltage at the output 14b to the USB connector 16 only when the Bluetooth circuit is paired to the mobile device. As long as there is no Bluetooth signal or there is no successful pairing with of the Bluetooth circuit 24 the charging voltage at the output 14b is withheld from the USB connector 16. Therefore, without successful Bluetooth pairing any device plugged into the USB connector 16 will not be charged.

According to a presently preferred embodiment the Bluetooth Circuit 24 includes a memory 24′ to store the Bluetooth pairing information first used to pair with a mobile device. Once that first pairing takes place another user will not be able to pair since the Bluetooth device will not match the pairing information first used to pair the charger. Only after an original authorized user has paired with charger 10 will the authorized user be able to change the information in the memory 24′ on a suitable application or “app” on a device to be charged such as a mobile phone, laptop or the like. However, unless the authorized user disables the originally stored information the charging unit will continue to be paired only with authorized device until that condition is modified by the authorized user. So, once pairing takes place and the switch 22 is closed it will remain closed until manually deactivated by the authorized device. While a physical or mechanical type switch is illustrated it is symbolic and any form of mechanical, electro-mechanical or purely electronic switch may be used, such as semi-conductor switches.

Another feature of the invention is the provision of a pin lock actuator 26 linked at 28 to locking pins 30, more fully shown in FIGS. 2 and 3. The link 28 may be a mechanical or electromechanical component that causes the locking pins 30 to move through appropriate openings, holes or recesses 16′ in the USB receptacle 16, for example, by applying a voltage at the input to the pin lock actuator 26. With this arrangement, a type-A male USB connector plug 32 on a charging cable for a mobile device inserted through the USB port 18 can be selectively locked within the female receptacle 16 or released depending on the pairing of the original device to be charged with the Bluetooth circuit 24. Again, once paired and the authorized cable is locked in place it will remain locked until modified by the authorized user on his or her portable device.

Referring to the FIGS. 2 and 3, the USB port 18 is the opening in the USB female receptacle 16 that can receive a mating USB male plug 32. Male USB plug 32 includes two spaced holes, apertures or openings 34 that become aligned or registered with the openings 16′ and locking pins 30. When the locking pins 30 are retracted or withdrawn from the openings 34 they allow the USB plug 32 to be freely inserted into the USB receptacle 16 through the port 18. However, once inserted and paired the USB plug 32 can be selectively locked or released by means of locking pins 30 as these are controlled by the Bluetooth circuit 24 and the pin lock actuator 26. The pin lock actuators 26 can be set up to lock a USB plug of a charging cable once inserted into the USB receptacle to prevent an unauthorized USB plug from being inserted into the USB receptacle 16. In the presently preferred embodiment, the pins 30 preferably remain in the extended or locking position once paired, within the holes or apertures 34, to prevent the charger 10 from being separated from an authorized USB plug of a charging cable inserted into the USB port 18. Once pairing has occurred, the switch 22 closes to apply DC power to the USB receptacle 16 and, therefore, to any authorized USB charging cable inserted into the port 18 while causing the pins 30 to be withdrawn from the apertures 34 to allow the authorized USB plug to be removed or separated from the charger 10.

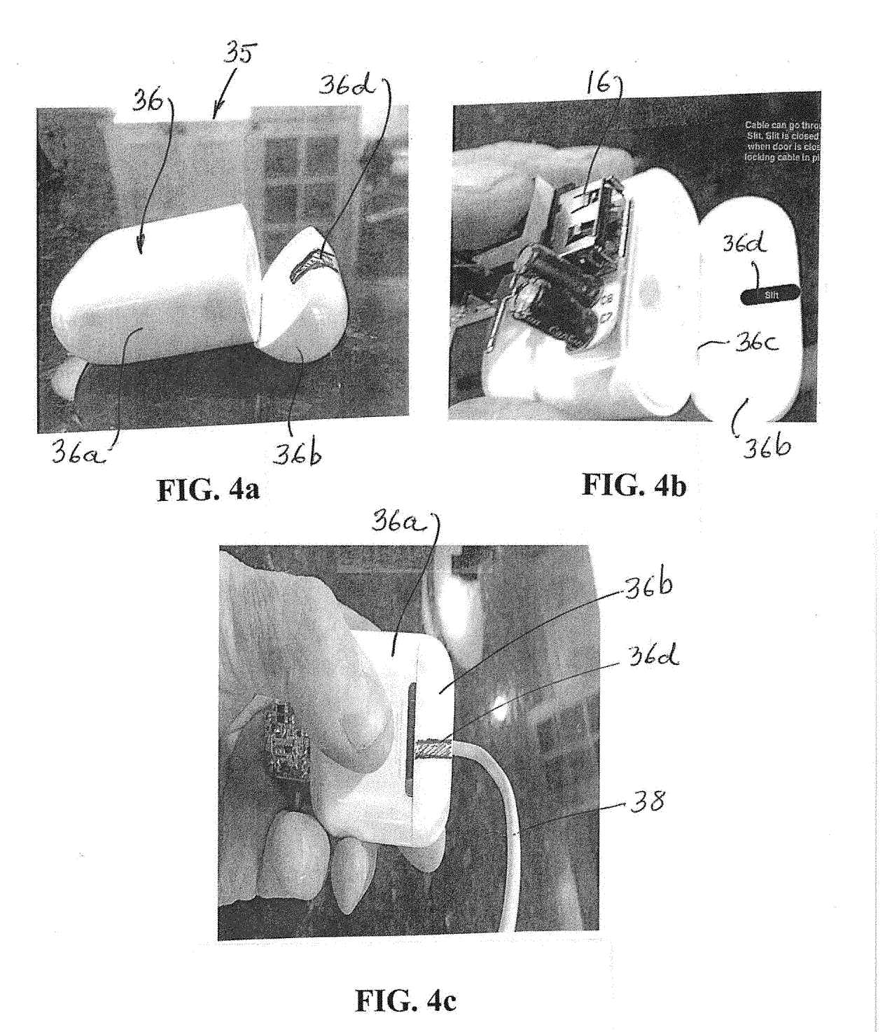

Referring to FIGS. 4a-4c, a modified adapter 35 is illustrated that has a housing 36 with a main body 36a with an interior compartment suitable for receiving a printed circuit board (PCB) 37 that includes the AC to DC conversion unit 14, the switch 22, the mating (e.g. Bluetooth) circuit 24, the pin actuator 26 and the USB receptacle 16—all shown in FIG. 1. The PCB 37 is also shown to support the USB receptacle. While the USB receptacle 16 is shown to be a USB-A receptacle the modified housing 36 is suitable for use with any USB type plug including the increasingly used USB Type-C plugs.

To make the adapter 35 more universal for all USB type charging plugs, a door or lid 36b is movably attached to the main body 36a by a living or plastic hinge 36c for movements between an open position (FIGS. 4a, 4b) and a closed position (FIG. 4c). The door or lid 36a includes a slit or slot 36d that extends from an edge opposite the living hinge 36d to an intermediate position as shown. The length of orientation of the slit or slot 36d is not critical as long as it can receive a charging cable 38 after a suitable USB plug has been mated with an associated USB receptacle 16 on the PCB 37. After the cable is connected and the adapter 35 is mated, such as with Bluetooth, the pin lock actuator 26 can be used to move a pin 30 (or other closure or locking member) to lock the door or lid in the closed condition as previously discussed. However, because some USB plugs, such as the Type-C do not have holes or recesses, a comparable cable locking function can be achieved by locking the lid or door. Since the body of USB connectors invariably have larger or greater dimensions than the cross section of the cables to which they are attached the USB plugs cannot be withdrawn through the slit or slot 36d. Therefore, locking of the door or lid 36d in the closed position automatically also locks any style USB plug from being removed.

The PCB 37 can also support two or more styled USB receptacles, such as Type-A and Type-C receptacles so that appropriate mating can be effected prior to closure of the door or lid 36b.

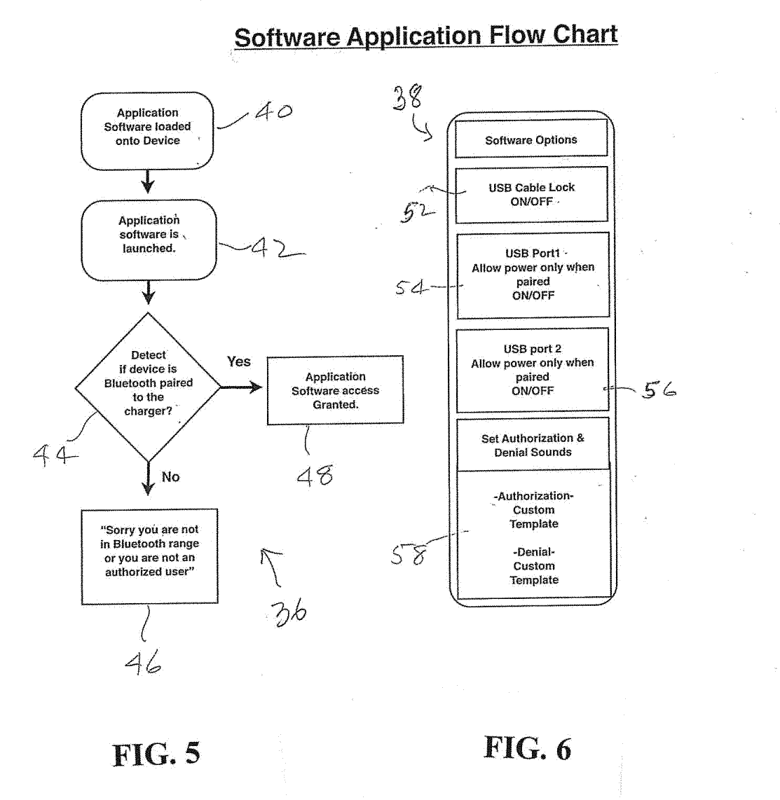

Referring to FIG. 5, the sequence of steps is illustrated for implementing the cable locking feature of the invention. Initially, application software is loaded onto the mobile device at 40, the mobile device being the initially paired authorized device to be associated with the cable locking charger. In use, the application software is launched within the device at 42. In order to utilize the charger an attempt is made to pair the charger to the mobile device in accordance with conventional Bluetooth technology, at 44. If the device fails to pair with the charger the application or app can generate a visual or audible message indicating that the charger is out of range or that the device is not an authorized, at 46. If the pairing by the authorized device is detected the application software grants access to the charger at 48. Once pairing takes place the charger switch 22 closes to apply power to the USB receptacle 16 and, as suggested above, the pins 30 are extended into the holes or apertures 34 to lock the authorized cable within the charger so that charging can take place.

Referring to FIG. 6, software options 38 are illustrated. As indicated, the USB cable lock actuator pins can be toggled on or off at 52 by the initial authorized device as a function of pairing, at 54. The USB port 18 can be powered only when paired and power turned off when not paired.

The charging unit can be programmed by the app on the authorized device to continue to lock the authorized cable within the receptacle 16 even when pairing is terminated and the switch 22 is opened to remove power from the authorized cable. This avoids use by any unauthorized unpaired device. At 56, a similar function can be provided to a second USB port 2 that can be controlled by the app when the charger is provided with dual USB ports. It is contemplated by the present invention that USB port 1 can be protected while USB port 2 is always available when authorized by the app on the authorized device to power a mobile device regardless of whether the devices are paired to provide a “guest” port. These ports can be connected in parallel so that power can be either applied or removed from both port simultaneously when an authorized user seeks to charge to mobile devices simultaneously. However, neither port will provide any power to an unauthorized user unless power is enabled by the app on the authorized device. At 58, various authorization and denial sounds can be issued, such as verbal voice messages whether preset or customized.

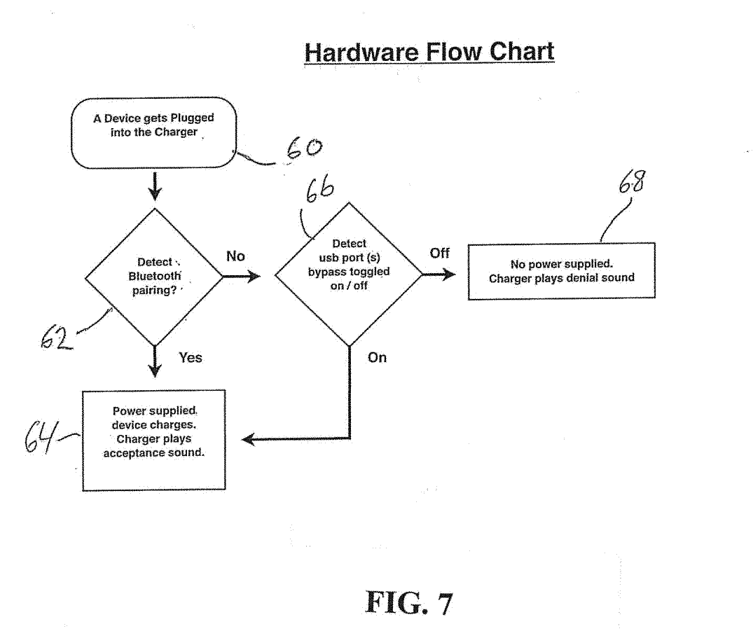

Referring to FIG. 7, a hardware flowchart summarizes the operation of the Bluetooth cable locking charger. Initially, a device is plugged into the charger at 60, indicating that the pins of 30 are withdrawn to provide a USB plug access to the USB receptacle 16. The application or app on the mobile device cooperates with the Bluetooth circuit 24 to determine if pairing takes place at 62. If pairing is detected power is supplied at 64 and the authorized device can be charged. The charger may optionally issue acceptance sounds or indications. If pairing is not detected, the application software determines that an USB authorized cable is not detected at 66 and power is not supplied and the charger and optional denial sounds or other indication at 68 may be provided. However, the application software and the authorized device may also optionally be provided with a feature to provide a bypass toggle on or off so that the switch 22 remains closed to let third parties use the charger even though those devices are not paired to the charger. In that eventuality, the power is supplied and any device that is plugged into the charger is charged at 64. An authorized user of the charger can optionally elect to have the charger perform as an ordinary charger that can be used by all users but only when the bypasses feature is toggled to on. When toggled off, unauthorized user cannot use the charger has indicated.

Application Software will allow a person to interact with the charger when it is paired
A) Control the Access to the chargers USB charging ports. The authorized Bluetooth paired user will have the ability to toggle the USB charging ports power on or off. This function would allow access for a non paired device to use the product for charging.
B) Custom Denial/Acceptance Sounds: When an unauthorized/unpaired device plugs into the USB port the charger will play an audible rejection tone or a custom recording. Example “Sorry, no charging for you!”
   This same feature can be enabled to play an audible acceptance tone or a custom recording if device is paired to charger. Example “Hello, charging initiated”

### Internal Rechargeable Battery:

Charger has a on board rechargeable battery that can double as an off grid power supply unit.

### Different Power Output Options:

Some devices charge at 1.0 A others are 2.1 A. The charger will offer multiple power output options.

### Different Power Plugs Heads:

Power head can be purchased for international outlets Night Lite: Small Multi colored LED.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed:

1. A USB charger comprising an AC to DC conversion unit for generating a charging voltage and current when connected to a source of AC voltage;
a USB receptacle having power connection pins for transferring a DC voltage to a USB plug connected to a mobile device to be charged;
a switch between said AC to DC conversion unit and said USB receptacle for selectively applying and/or removing said DC voltage from said power connection pins in said USB receptacle; and
a pairing circuit for selectively opening or closing said switch only in response to instruction provided by a mobile device paired with said pairing circuit.

2. A USB charger comprising an AC to DC conversion unit for generating a charging voltage as defined in claim 1, wherein said USB receptacle and plug are type-A USB connectors.

3. A USB charger comprising an AC to DC conversion unit for generating a charging voltage as defined in claim 1, wherein said USB plug is connected to a charging cable and is provided with at least one recess or aperture in an external sheath shield further comprising a lock actuator for selectively locking or releasing said USB plug from said USB receptacle under the control of a paired mobile device.

4. A USB charger comprising an AC to DC conversion unit for generating a charging voltage as defined in claim 1, wherein said USB plug is connected to a charging cable, said conversion unit comprising a housing with a door or lid movable between first and second positions for opening and closing said housing, said door or lid including an opening dimensioned to only allow passage of a charging cable and providing access to said USB receptacle when in the open position of said door or lid.

5. A USB charger comprising an AC to DC conversion unit for generating a charging voltage as defined in claim 1, wherein said pairing circuit includes a memory for storing pairing information for a specific mobile device, whereby the charger cannot be paired to another mobile device without specific authorization of the first paired mobile device.

6. A USB charger comprising an AC to DC conversion unit for generating a charging voltage as defined in claim 4, wherein said door or lid is secured by a plastic or living hinge and said opening for a charging cable comprises a slot or slit extending from an edge opposite to said living hinge to an intermediate position short of said living hinge.

7. A USB charger comprising an AC to DC conversion unit for generating a charging voltage as defined in claim 1, wherein said lock actuator comprises a pin associated with each of said at least one recess or aperture.

8. The combination of a USB charger and a mobile device, said USB charger comprising an AC to DC conversion unit for generating a charging voltage and current when connected to a source of AC voltage;
AC to DC conversion unit for generating a charging voltage and current when connected to a source of AC voltage;
a USB receptacle having power connection pins for transferring a DC voltage to a USB plug connected to a mobile device to be charged;
a switch between said AC to DC conversion unit and said USB receptacle for selectively applying and/or removing said DC voltage from said power connection pins in said USB receptacle; and
a pairing circuit for selectively opening or closing said switch only in response to instruction provided by a mobile device paired with said pairing circuit.

9. A USB charger comprising an AC to DC conversion unit for generating a charging voltage as defined in claim 8, wherein said USB receptacle and plug are mating USB connectors.

10. A USB charger comprising an AC to DC conversion unit for generating a charging voltage as defined in claim 8, wherein said door or lid is secured by a plastic or living hinge and said opening for a charging cable comprises a slot or slit extending from an edge opposite to said living hinge to an intermediate position short of said living hinge.

11. A USB charger comprising an AC to DC conversion unit for generating a charging voltage as defined in claim 8, wherein said pairing circuit is a Bluetooth circuit.

12. A USB charger comprising an AC to DC conversion unit for generating a charging voltage as defined in claim 11, wherein said Bluetooth circuit includes a memory for storing pairing information for a specific mobile device, whereby the charger cannot be paired to another mobile device without specific authorization of the first paired mobile device.

13. A USB charger comprising an AC to DC conversion unit for generating a charging voltage as defined in claim 8, wherein said lock actuator, wherein said USB plug is connected to a charging cable and is provided with at least one recess or aperture in an external sheath shield and said lock actuator comprises pin actuator for selectively inserting and withdrawing at least one pin within said at least one recess or aperture.

14. A USB charger comprising an AC to DC conversion unit for generating a charging voltage as defined in claim 13, wherein said lock actuator comprises a pin associated with each of said at least one recess or aperture.

15. A USB charger comprising an AC to DC conversion unit for generating a charging voltage as defined in claim 8, wherein said mobile device is programmed with an app to selectively lock the charging cable, release the charging cable and apply DC voltage when the paired mobile device is attached to or removed from the charger.

16. A method of controlling a charger comprising an AC to DC conversion unit for generating a charging voltage and current when connected to a source of AC voltage, comprising the steps of loading application software onto the mobile device;
launching said application software;
detecting whether the mobile device is paired to the charger;
applying a DC voltage to the mobile device only when paired to the charger; and
withholding a DC voltage to the mobile device in the absence of proper pairing with the charger.

17. A USB charger comprising an AC to DC conversion unit for generating a charging voltage as defined in claim 16, wherein pairing uses Bluetooth.

18. A USB charger comprising an AC to DC conversion unit for generating a charging voltage as defined in claim 16, further providing an indication when pairing does not take place and charging is denied.

19. A USB charger comprising an AC to DC conversion unit for generating a charging voltage as defined in claim 18, wherein said indication is at least one of a verbal and visual indication.

20. A USB charger comprising an AC to DC conversion unit for generating a charging voltage as defined in claim 16, further comprising an indication when pairing takes place and power is supplied to the mobile device.
